(19) United States
(12) Patent Application Publication
(10) Pub. No.: US 2012/0048749 A1
(43) Pub. Date: Mar. 1, 2012

(54) PROTON CONDUCTOR, METHOD OF PRODUCING THE SAME, AND CARBON QUANTITY DETECTING SENSOR

(75) Inventors: Toshihiko Harada, Toyohashi-shi (JP); Keigo Mizutani, Okazaki-shi (JP); Shinya Teranishi, Chita-gun (JP); Satoshi Nakamura, Okazaki-shi (JP); Yushi Fukuda, Chita-gun (JP); Takashi Hibino, Nagoya (JP); Yanbai Shen, Nagoya (JP)

(73) Assignees: DENSO CORPORATION, Kariya-city (JP); NIPPON SOKEN, INC., Nishio-city (JP)

(21) Appl. No.: 13/222,099

(22) Filed: Aug. 31, 2011

(30) Foreign Application Priority Data
Sep. 1, 2010 (JP) 2010-195339

(51) Int. Cl. G01N 27/417; C04B 35/64; B05D 5/12; G01N 27/28; G01N 27/40

(52) U.S. Cl. 205/793; 427/126.1; 264/643; 204/425

(57) ABSTRACT

A proton conductor has a porous sintered body made of tetravalent metallic oxide. Pyrophosphate as tetravalent metallic compound is formed on surfaces and porous walls of the body, and in the inside of each pore of the body. A method produces the proton conductor by immersing the porous sintered body made of tetravalent metallic oxide into liquid solvent containing phosphate, and heating the porous sintered body at 400° C. over 4 hours. A carbon quantity detecting sensor has the proton conductor, a pair of a measuring electrode and a reference electrode, and an electric power source for supplying a predetermined current or voltage to the electrode pair composed of the measuring and reference electrodes. The measuring electrode is formed on one surface of the proton conductor to face the measuring gas. The reference electrode is formed on the other surface of the proton conductor to be apart from the measuring gas.

### CROSS-REFERENCE TO RELATED APPLICATION

This application is related to and claims priority from Japanese Patent Application No. 2010-195339 filed on Sep. 1, 2010, the contents of which are hereby incorporated by reference.

### BACKGROUND OF THE INVENTION

1. Field of the Invention

The present invention relates to proton conductors, methods of producing the proton conductors and carbon quantity detecting sensors, where the proton conductor is composed of a porous sintered body and pyrophosphate as a tetravalent metallic compound formed on surfaces and porous walls of the porous sintered body, and the inside of each pore in the porous sintered body.

2. Description of the Related Art

In recent years, various researches for proton conductors have been widely performed. Such a proton conductor is suitable for an electrolyte used in a fuel cell, etc. The proton conductor has protons producing high electric conductivity under an environment with a predetermined temperature range of not less than 100° C. The electric conductivity of a proton conductor will also be referred to as the “proton conductivity”. In particular, pyrophosphate MP₂O₇ (M represents one of Si, Ge, Sn and Ti as a tetravalent metallic element) has a high proton conductivity under an intermediate temperature range of 100 to 400° C. (see M. Nagao et al. Journal of the Electrochemical Society, 2006, vol. 153, No. 8, pp. A1604-A1609)

However, because pyrophosphate MP₂O₇ has a sintering resistant feature which makes it difficult to sinter, it is possible for the conventional techniques to use a press-formed mold body of pyrophosphate MP₂O₇ powder only. This makes it impossible to obtain any proton conductor having an adequate mechanical strength. Further, because such a conventional proton conductor is a press-formed mold body produced by pressing pyrophosphate MP₂O₇ powder, gas leakage occurs in the proton conductor. Accordingly, it is difficult to apply a conventional proton conductor to the fields of air-tight devices which require the function of air-tightness.

In order to solve the drawback of the above conventional proton conductors, there is a conventional technique disclosed in a PCT international laid open publication No. WO 2007083835 A1, which produced excess phosphate on the surface of pyrophosphate. Further, there is another conventional technique disclosed in a Japanese patent laid open publication No. 2009-249194, which produces a dense press-mold body by changing a precursor of a known pyrophosphate. Still further, there is another conventional technique disclosed in Japanese patent laid open publication No. 2010-103000, which provides electrolyte film with increased mechanical strength and gas barrier capability by making a composite of metal pyrophosphate, organic polymeric compound containing nitrogen system and synthetic resin.

However, the conventional mold body made of pyrophosphate disclosed in the above conventional techniques has a low mechanical strength because the conventional techniques provide a press-formed mold body only. In addition, the conventional composite of pyrophosphate and organic compound has a measure of heat flow, namely, is not sufficiently heat resistant.

### SUMMARY OF THE INVENTION

It is an object of the present invention to provide a proton conductor with high proton conductivity and mechanical strength, a method of producing the proton conductor, and a carbon quantity detecting sensor equipped with the proton conductor.

To achieve the above purposes, the present exemplary embodiment provides a proton conductor having a porous sintered body made of tetravalent metallic oxide. Pyrophosphate as a tetravalent metallic compound is further formed on surfaces of the porous sintered body, porous walls of the porous sintered body, and in the inside of each pore of the porous sintered body.

In the proton conductor according to the present exemplary embodiment of the present invention, a pyrophosphate which is a tetravalent metallic compound and is formed on surfaces and porous walls of the porous sintered body, and in the inside of each pore of the porous sintered body. This makes it possible for the proton conductor to show a superior proton conductivity at a high temperature because of being able to use a superior proton conductivity of pyrophosphate.

In the proton conductor according to the present exemplary embodiment, because the pyrophosphate as a tetravalent metallic compound is further formed on surfaces and porous walls of the porous sintered body, and in the inside of each pore of the porous sintered body, it is possible for the proton conductor to provide a superior mechanical strength when compared with a mechanical strength of a conventional proton conductor.

In the proton conductor according to the present exemplary embodiment, the pyrophosphate as a tetravalent metallic compound is further formed in the inside of each pore of the porous sintered body. This makes it possible for the proton conductor to have an air-tight structure and to prevent gas leakage from occurring. It is therefore possible to apply the proton conductor according to the present exemplary embodiment to various applications such as fuel cells and carbon quantity detecting sensors (which will be explained later in detail) which requires a highly air-tight capability.

The present exemplary embodiment provides a method of producing a proton conductor. The method has a step of contacting (or immersing) a porous sintered body made of tetravalent metallic oxide with liquid solvent containing phosphate, and a step of heating the porous sintered body so that the pyrophosphate which is a tetravalent metallic compound is formed on a surface and porous walls and in the inside of each pore of the porous sintered body.

In the method according to the present exemplary embodiment, a porous sintered body made of tetravalent metallic oxide is in contact with (or is immersed into) liquid solvent containing phosphate, and the porous sintered body is heated so that the pyrophosphate as a tetravalent metallic compound is formed on the surfaces and porous walls of the porous sintered body and in an inside of the pores of the porous sintered body. That is, the method according to the present exemplary embodiment can produce the porous conductor having the superior capabilities as previously described. The porous conductor produced by the method exhibits the superior mechanical strength and the superior proton conductivity under a high temperature condition because of being able to use a superior proton conductivity of pyrophosphate.

In the method of producing the proton conductor, such a porous sintered body made of tetravalent metallic oxide is in contact with (or immersed into) liquid solvent containing phosphate, and the obtained porous sintered body is heated at a predetermined temperature. This makes it possible for the tetravalent metallic compound forming the porous sintered body to react with phosphate. This reaction produces pyrophosphate as tetravalent cation. In particular, the pyrophosphate is formed in the inside of each pore formed in the porous sintered body in addition to on the surfaces and porous walls of the porous sintered body. This means that the inside of each pore formed in the porous sintered body is filled with the pyrophosphate generated by the above reaction. As a result, the present invention can provide the proton conductor with an air-tight structure without gas leakage.

The present exemplary embodiment provides a carbon quantity detecting sensor. In general, the carbon quantity detecting sensor is placed in a gas flow passage through which a measuring gas containing carbon component flows. The carbon quantity detecting sensor detects a quantity of carbon contained in the measuring gas. The carbon quantity detecting sensor has the proton conductor as previously described, a pair of a measuring electrode and a reference electrode, and an electric power source.

The measuring electrode is formed on one surface of the proton conductor. The reference electrode is formed on the other surface of the proton conductor. The reference electrode is formed on the other surface of the proton conductor. The measuring electrode faces the measuring gas. The reference electrode is apart from the measuring gas. The electric power source supplies a predetermined current or a predetermined voltage to the electrode pair composed of the measuring electrode and the reference electrode.

In the carbon quantity detecting sensor according to the present exemplary embodiment, carbon component contained in a measuring gas is oxidized by electro chemical reaction while the power source supplies electric power to the electrode pair composed of the measuring electrode and the reference electrode. This makes it possible for a control unit to receive a detection signal transferred from the carbon quantity detecting sensor and to calculate the quantity of carbon component contained in the measuring gas on the basis of the received detection signal such as a current value or a voltage value output from the carbon quantity detecting sensor. In particular, because the carbon quantity detecting sensor is equipped with the proton conductor having a superior proton conductivity, as previously described, it is possible to provide the carbon quantity detecting sensor with a high detection capability to detect the quantity of carbon component contained in the measuring gas.

In addition, the carbon quantity detecting sensor can be applied to exhaust gas purifying systems. That is, the carbon quantity detecting sensor is used as a sensor for detecting a quantity of carbon such as particulate matter contained in an exhaust gas emitted from an internal combustion engine of a motor vehicle. Still further, the above superior features make it possible to prevent the carbon quantity detecting sensor with the proton conductor from being damaged and broken even if the carbon quantity detecting sensor is used in strict environment such as in high temperature and highly vibration condition when a vehicle is running.

Still further, because the proton conductor according to the present exemplary embodiment has a superior air-tight capability, it is possible to prevent gas leakage in the carbon quantity detecting sensor from occurring. This provides and guarantees long life and durability of the carbon quantity detecting sensor with high reliability for a long period of time.

### BRIEF DESCRIPTION OF THE DRAWINGS

A preferred, non-limiting embodiment of the present invention will be described by way of example with reference to the accompanying drawings, in which:

FIG. 1 is a view showing a X ray diffraction (XRD) pattern of a surface of a proton conductor (sample E1) according to a first exemplary embodiment of the present invention;

FIG. 2 is a view showing a X ray diffraction (XRD) pattern of an inside of a proton conductor (sample E1) according to the first exemplary embodiment of the present invention;

FIG. 3A shows a SEM photograph of the porous sintered body (sample C1) according to the first exemplary embodiment of the present invention;

FIG. 3B shows a SEM photograph of the proton conductor (sample E1) according to the first exemplary embodiment of the present invention;

FIG. 4A is a view explaining an energy-dispersive X-ray fluorescence analyzed image of Sn element in the porous sintered body (sample C1);

FIG. 4B is a view explaining an energy-dispersive X-ray fluorescence analyzed image of Sn element in the proton conductor (sample E1);

FIG. 5A is a view explaining an energy-dispersive X-ray fluorescence analyzed image of P element in the porous sintered body (sample C1);

FIG. 5B is a view explaining an energy-dispersive X-ray fluorescence analyzed image of P element in the proton conductor (sample E1);

FIG. 6 is a development elevation of a device for detecting an air-tight capability of the proton conductor according to the first exemplary embodiment of the present invention;

FIG. 7 is a view showing a cross section of the device for detecting the air-tight capability of the proton conductor according to the first exemplary embodiment of the present invention;

FIG. 8 is a view showing a relationship of a temperature and a concentration of hydrogen leak gas between the proton conductor (sample E1) and the porous sintered body (sample C1) according to the first exemplary embodiment of the present invention;

FIG. 9 is a development elevation of a device for detecting an air-tight capability of the proton conductor according to a second exemplary embodiment of the present invention;

FIG. 10 is a view showing a relationship of a temperature and an electric conductivity between proton conductors (samples E1 to E6) and the porous sintered body (sample C1) according to the second exemplary embodiment of the present invention;

FIG. 11 is a view showing a relationship of a temperature and an electric conductivity between proton conductors (samples E1, E7 and E8) and the porous sintered bodies (samples C1 to C3) according to a third exemplary embodiment of the present invention;

FIG. 12 is a view showing a schematic configuration of a carbon quantity detecting sensor according to a fourth embodiment of the present invention;

FIG. 13 is a development view showing a schematic configuration of a carbon quantity detecting element in the carbon quantity detecting sensor according to the fourth embodiment of the present invention;

FIG. 14 is a view showing a relationship between a detection time and a detection current by the carbon quantity detecting sensor according to the fourth embodiment of the present invention;

FIG. 15 is a view showing a relationship between a carbon concentration and a detection current of the carbon quantity detecting sensor according to the fourth embodiment of the present invention; and

FIG. 16 is a flow chart showing a method of producing a proton conductor according to an exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

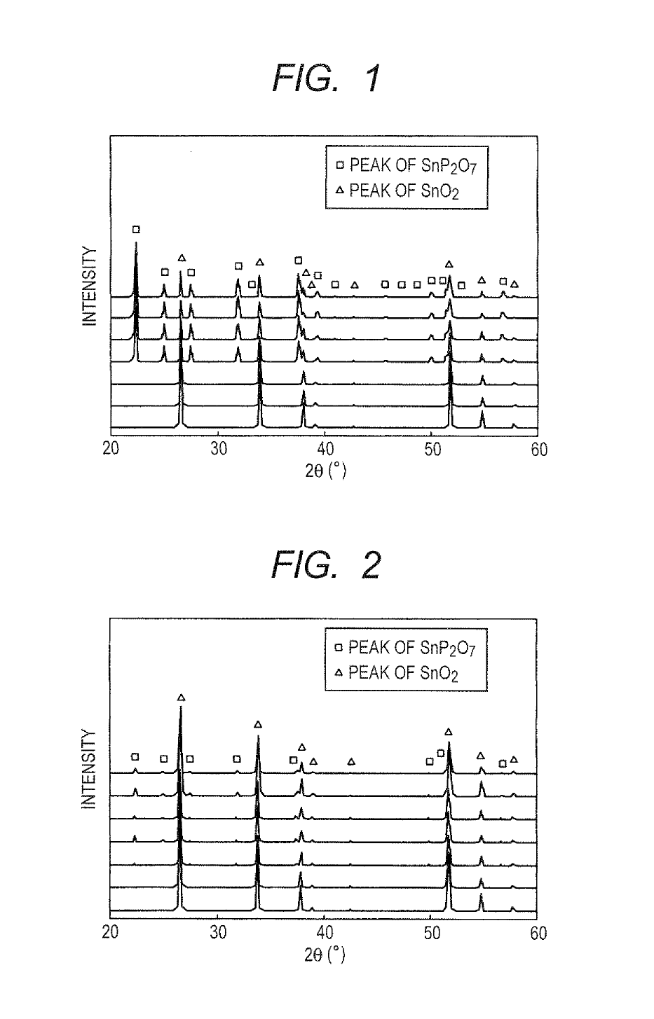

A description will be given of a proton conductor according to explanatory embodiments with reference to FIG. 1 to FIG. 8.

The first explanatory embodiment produces a proton conductor having a porous sintered body made of tin (IV) oxide (SnO₂) in which tin (IV) pyrophosphate (SnP₂O₇) is formed in porous walls of the porous sintered body and in the inside of each pore formed in the porous sintered body. In a method of producing the proton conductor, such a porous sintered body made of tin (IV) oxide (SnO₂) is immersed into or in contact with liquid solvent containing phosphate, and the porous sintered body is then heated.

A description will now be given of the method of producing the proton conductor according to the first exemplary embodiment of the present invention.

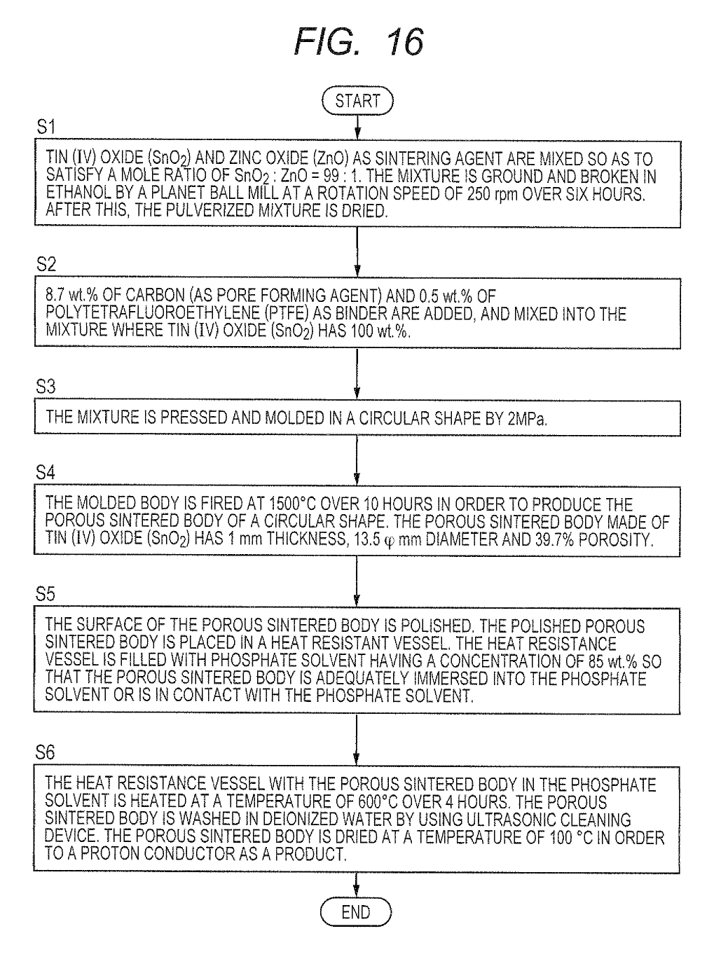

FIG. 16 is a flow chart showing a method of producing the proton conductor according to the exemplary embodiment of the present invention.

At first, a porous sintered body made of tin (IV) oxide (SnO₂) is produced as follows.

In step S1, tin (IV) oxide (SnO₂) and zinc oxide (ZnO) as sintering agent are mixed so as to satisfy a mole ratio of SnO₂:ZnO=99:1.

Next, the mixture is ground and pulverized ethanol by a planet ball mill at a rotation speed of 250 rpm over six hours. After this, the pulverized mixture is dried.

In step S2, 8.7 wt. % of carbon as pore forming agent, and 0.5 wt. % of polytetrafluoroethylene (PTFE) as binder are added and mixed into the mixture where tin (IV) oxide (SnO₂) has 100 wt. %. Such carbon as pore forming agent is removed during a firing step.

In step S3, the mixture is pressed and molded into a circular plate shape under 2 MPa of pressure.

In step S4, the molded body is fired at 1500° C. over 10 hours. The porous sintered body of a circular shape is produced. The porous sintered body made of tin (IV) oxide (SnO₂) has 1 mm thickness, 13.5 φ mm diameter and 39.7% porosity. This porous sintered body will be referred to as the “sample C1”.

In step S5, the surface of the porous sintered body is polished. The polished porous sintered body is placed in a heat resistant vessel. The heat resistant vessel is filled with phosphate solvent having a concentration of 85 wt. % so that the porous sintered body is adequately immersed into the phosphate solvent or is adequately in contact with the phosphate solvent.

In step S6, the heat resistant vessel with the porous sintered body in the phosphate solvent is heated at a temperature of 600° C. over 4 hours. The porous sintered body is then washed in deionized water by using ultrasonic cleaning device. After this, the porous sintered body is dried at a temperature of 100° C. in order to a proton conductor as a product. This proton conductor will be referred to as the “sample E1”. The method of producing the proton conductor is completed.

A X-ray diffraction (XRD, 2θ method) using CuKα ray was executed for the surface and the inside of the sample E1 produced by the above method.

FIG. 1 is a view showing a X ray diffraction (XRD) pattern of a surface of the proton conductor (sample E1) according to the first exemplary embodiment of the present invention. FIG. 2 is a view showing a X ray diffraction (XRD) pattern of an inside of the proton conductor (sample E1) according to the first exemplary embodiment of the present invention.

In FIG. 1 and FIG. 2, the horizontal axis indicates an angle 2θ(°) of diffraction, and the vertical axis indicates an intensity ratio, reference character “□” indicates the peak position of tin (IV) pyrophosphate (SnP₂O₇), and reference character “Δ” indicates the intrinsic peak position of tin (IV) oxide (SnO₂).

As can be understood from the detection results shown in FIG. 1 and FIG. 2, the surface and the inside of the proton conductor (sample E1) have an intrinsic peak of tin (IV) pyrophosphate (SnP₂O₇) which is different from an intrinsic peak of tin oxide (SnO₂).

As being not clearly shown in FIG. 1 and FIG. 2, other test samples as different proton conductors produced at various heating temperatures, which are different from the heating temperature at which the sample E1 is produced have a tendency to increase the diffraction peak of the tin pyrophosphate (SnP₂O₇) according to increasing the heating temperature.

In addition, the first exemplary embodiment detects the porous sintered body (sample C1) before immersed into the liquid solvent containing phosphate or is in contact with the liquid solvent containing phosphate, and detects the proton conductor (sample E1) by using a scanning electron microscope (SEM).

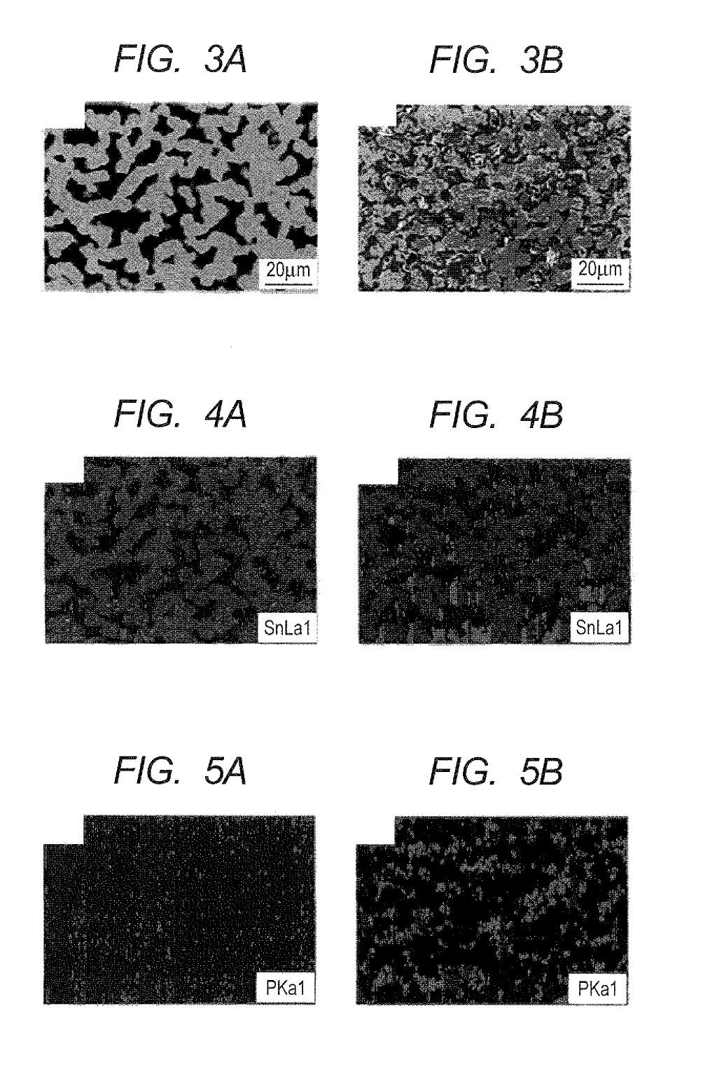

FIG. 3A is a SEM photograph of the porous sintered body (sample C1) according to the first exemplary embodiment of the present invention. FIG. 3B is a SEM photograph of the proton conductor (sample E1) according to the first exemplary embodiment of the present invention.

Further, the first exemplary embodiment detects the distribution of Sn element and P element in the porous sintered body (sample C1) and the proton conductor (sample E1) by using an energy-dispersive X-ray fluorescence analyzing device (EDX)

FIG. 4A is a view explaining an energy-dispersive X-ray fluorescence analyzed image of Sn element in the porous sintered body (sample C1). FIG. 4B is a view explaining an energy-dispersive X-ray fluorescence analyzed image of Sn element in the proton conductor (sample E1).

Still further, FIG. 5A is a view explaining an energy-dispersive X-ray fluorescence analyzed image of P element in the porous sintered body (sample C1). FIG. 5B is a view explaining an energy-dispersive X-ray fluorescence analyzed image of P element in the proton conductor (sample E1).

In FIG. 4A, FIG. 4B, FIG. 5A and FIG. 5B, a target element (Sn or P) is designated at the right-side bottom in each EDX image photograph. In particular, “La1” indicates Lα1 line as a characteristic X ray and “Ka1” indicates Kα1 line as a characteristic X ray.

As can be understood from the detection results shown in FIG. 3A to FIG. 5B and the detection results from FIG. 1 and FIG. 2, the porous sintered body (sample C1) does not contain any tin pyrophosphate (SnP₂O₇). In other words, the inside of each pore in the porous sintered body (sample C1) is empty. On the other hand, tin pyrophosphate (SnP₂O₇) is generated on the surface and the porous walls, and in the inside of each pore in the proton conductor (sample E1). The inside of each pore in the proton conductor (sample E1) is not empty and contains or is filled with tin pyrophosphate (SnP₂O₇).

Next, a description will now be given of the evaluation results of the air tightness of the proton conductor (sample E1).

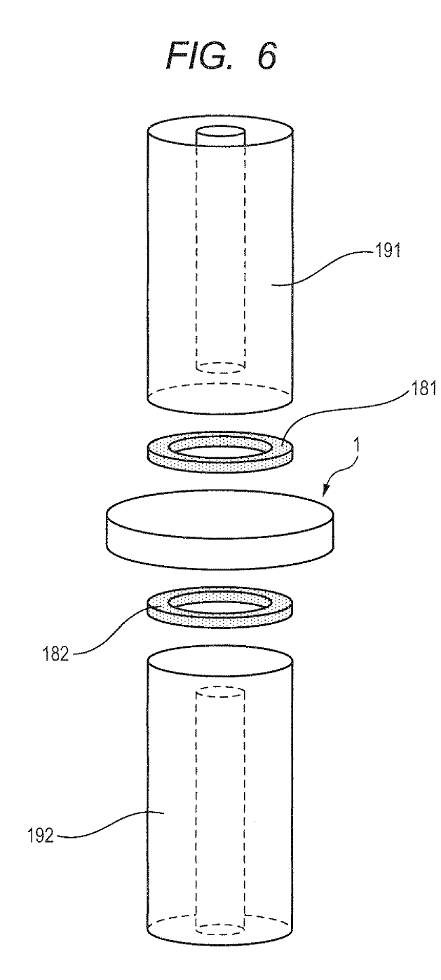

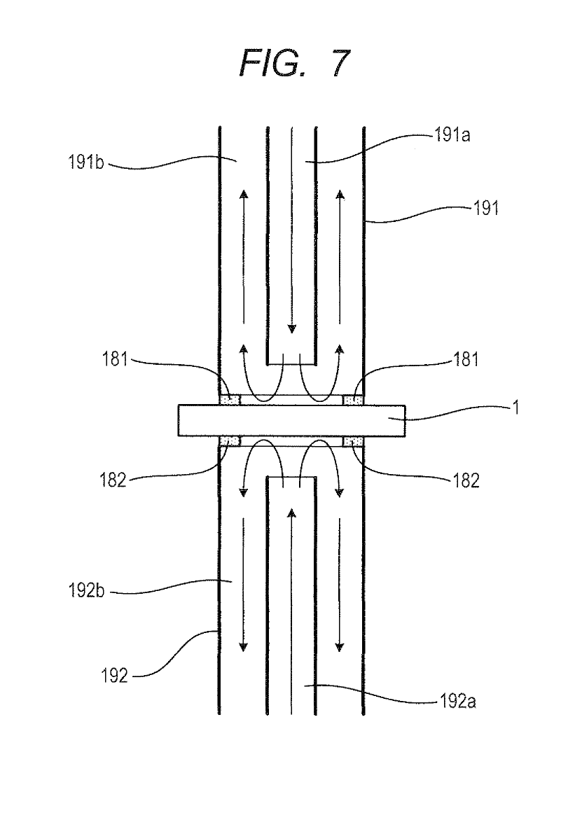

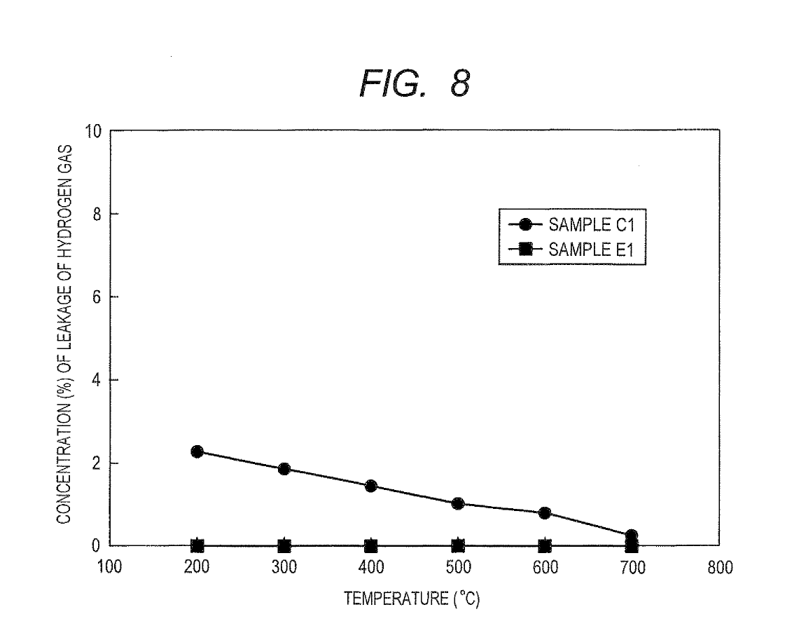

FIG. 6 is a development elevation of a device for detecting the air-tight capability of the proton conductor according to the first exemplary embodiment of the present invention. FIG. 7 is a view showing a cross section of the device for detecting the air-tight capability of the proton conductor according to the first exemplary embodiment of the present invention.

As shown in FIG. 7, the proton conductor 1 (sample E1) of a disk-like shape is placed between a pair of gas tubes 191 and 192. The gap between the proton conductor 1 (sample E1) and the gas tube 191 and the gap between the proton conductor 1 (sample E1) and the gas tube 192 are completely sealed with glass seal 181 and 182, respectively.

As shown in FIG. 7, the gas tube 191 is composed of a central tube 191a and an outer tube 191b, and the gas tube 192 is composed of a central tube 192a and an outer tube 192b. That is, the gas tube 191 has a double structure in which the central tube 191a is placed in the inside of the outer tube 191b. Similarly, the gas tube 192 has a double structure in which the central tube 192a is placed in the inside of the outer tube 192b.

When gas is introduced into the inside of the central tubes 191a and 192a, the gas is exhausted to the outside of the gas tubes 191 and 192 through the outer tubes 191b and 192b.

Next, the proton conductor (sample E1) which is sandwiched by the gas tubes 191 and 192 is placed in a vertical-tube type furnace (not shown). Argon gas containing 10% by volume is supplied into the inside of the central tube 191a of the gas tube 191 through the upper side of the vertical-tube type furnace. Further, such argon gas is also supplied to the inside of the central tube 192a of the gas tube 192 through the bottom side of the vertical-tube type furnace. A hydrogen concentration of the gas exhausted through the gas tube 192 (namely, through the outer tube 192b) at the bottom side is detected by a gas chromatography device (not shown) attached to the gas exhaust outlet of the gas tube 192 at the bottom side of the vertical-tube type furnace. That is, in the above evaluation test, when the gas leaks from the proton conductor 1, the hydrogen gas supplied from the upper side gas tube 191 and passes through the proton conductor 1 and is exhausted from the bottom side gas tube 192. The gas chromatography device detects such hydrogen gas discharged from the bottom side gas tube 192. The concentration of hydrogen gas is detected within a temperature range of 200 to 700° C. in the inside of the vertical-tube type furnace.

In addition, the air-tight resistant test is executed for another sample of porous sintered body (sample C1) in order to compare the detection results of the proton conductor 1 (sample E1). FIG. 8 shows the comparison results. That is, FIG. 8 is a view showing a relationship of a temperature and a concentration of hydrogen leak gas between the proton conductor (sample E1) and the porous sintered body (sample C1) according to the first exemplary embodiment of the present invention.

In FIG. 8, the horizontal axis indicates a detection temperature (° C.) and the vertical axis indicates a concentration (%) of hydrogen gas which leaks from the proton conductor (sample E1) and the porous sintered body (sample C1).

As clearly shown in FIG. 8, hydrogen gas passes through the porous sintered body (sample C1). In other words, the porous sintered body (sample C1) leaks hydrogen gas at a temperature within a range of 200 to 700° C. This indicates that hydrogen gas leakage occurs through gaps, namely, the inside of pores formed in the porous sintered body (sample C1).

On the other hand, there is no leakage of hydrogen gas from the proton conductor (sample E1) at a temperature within a range of 200 to 700° C. This means no hydrogen gas passes through the proton conductor (sample E1) because the inside of each pore formed in the porous sintered body of the proton conductor (sample E1) contains tin pyrophosphate (SnP₂O₇) and the proton conductor has a dense structure (or a compact structure).

As described above, the first exemplary embodiment can produce the proton conductor (sample E1) with a dense structure by immersing the porous sintered body made of tetravalent metallic oxide into liquid solvent containing phosphate (or being the porous sintered body in contact with liquid solvent containing phosphate), and then heating the porous sintered body. In the dense structure of the proton conductor according to the first exemplary embodiment, pyrophosphate MP₂O₇ as a tetravalent metallic oxide is formed on the surface and the porous walls and in the inside of the pores of the porous sintered body in the proton conductor (sample E1). Because this proton conductor is made of the porous sintered body has the capability of superior mechanical strength and the capability of air-tightness when compared with a conventional proton conductor made of a press-formed mold body.

### Second Exemplary Embodiment

A description will be given of the second exemplary embodiment.

The second exemplary embodiment produces a plurality of proton conductors (samples E2 to E6) under a different production condition which are different from the proton conductor (sample E1).

The second exemplary embodiment executes an electric conductivity test of the proton conductors (samples E2 to E6).

After each porous sintered body is immersed into (or is in contact with) liquid solvent containing phosphate, each porous sintered body is heated at a different temperature in order to produce each of the proton conductors (samples E2 to E6).

The sample E1 is produced by the method previously described.

The sample E2 is produced by heating at a temperature of 200° C. after the porous sintered body is immersed into (or is in contact with) liquid solvent containing phosphate.

The sample E3 is produced by heating at a temperature of 300° C. after the porous sintered body is immersed into (or is in contact with) liquid solvent containing phosphate.

The sample E4 is produced by heating at a temperature of 400° C. after the porous sintered body is immersed into (or is in contact with) liquid solvent containing phosphate.

The sample E5 is produced by heating at a temperature of 500° C. after the porous sintered body is immersed into (or is in contact with) liquid solvent containing phosphate.

The sample E6 is produced by heating at a temperature of 700° C. after the porous sintered body is immersed into (or is in contact with) liquid solvent containing phosphate.

The samples E1 to E6 are produced by the same method other than the heating temperature described above.

Next, the second exemplary embodiment evaluates the electric conductivity of each of the samples E1 to E6.

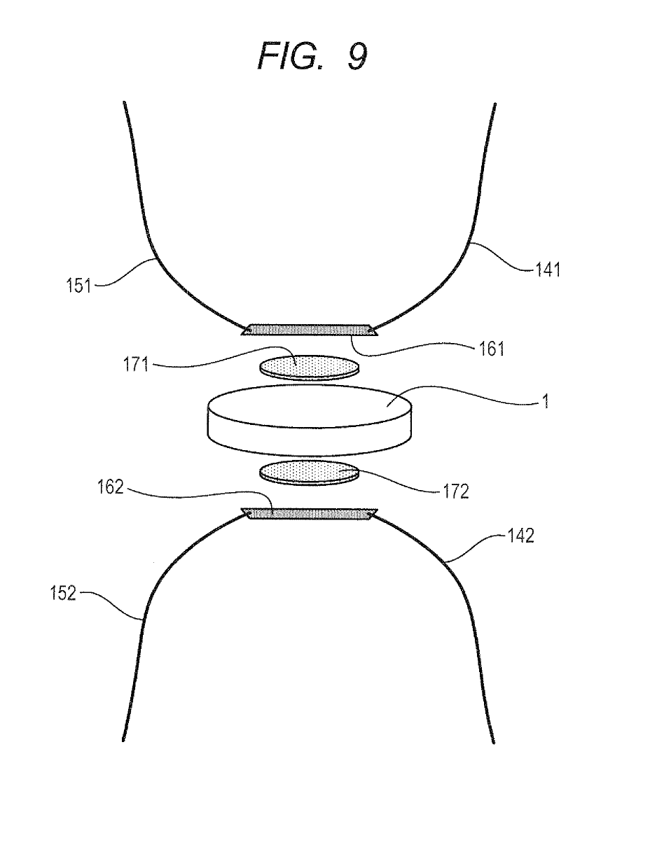

FIG. 9 is a development elevation of a device for detecting an air-tight capability of the proton conductor according to a second exemplary embodiment of the present invention.

As shown in FIG. 9, paired electrodes 171 and 172 are formed on both surfaces of the proton conductor (as each of the samples E1 to E6) of a disk-like shape. That is, the electrode 171 is formed on one surface of the proton conductor 1 and the electrode 172 is formed on the other surface of the proton conductor 1 by the following method.

At first, gold slurry is printed with an area of 0.785 cm² on each of the surfaces of the proton conductor 1. The proton conductor 1 is dried at a temperature of 105° C. and fired at a temperature of 400° C. over 2 hours. The proton conductor 1 with a pair of the electrodes 171 and 172 makes a cell (battery).

Next, electric collectors 161 and 162 made of platinum are formed on the gold electrodes 171 and 172 on the proton conductor 1, respectively. A pair of lead wires 141 and 151 is electrically connected to one electric collector 161 and a pair of lead wires 142 and 152 is electrically connected to the other electric collector 162.

A cell (which is composed of the porous conductor 1 with the gold electrodes 171 and 172) sandwiched by the electric collectors 161 and 162 is placed in a vertical tube type furnace. The furnace is heated from the room temperature to a temperature of 700° C. at an atmosphere. An electric conductivity of each of the samples E1 to E6 is detected by AC four electrode method (amplitude voltage: 10 mV, measuring frequency: 10 to 10⁶ Hz).

A comparison sample C1 is produced by using a porous sintered body which is different from the samples E1 to E6. The electric conductivity of the comparison sample C1 is detected by the same method of each of the samples E1 to E6.

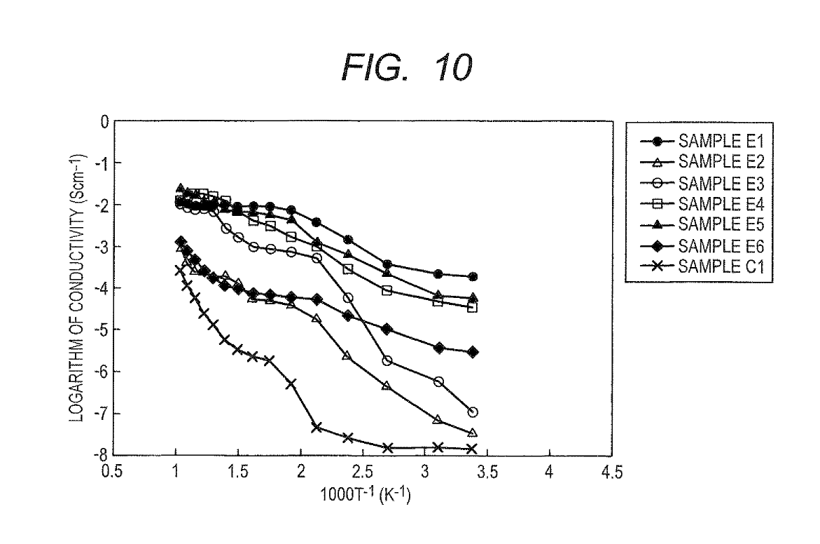

FIG. 10 is a view showing a relationship of temperature and electric conductivity between the proton conductors (samples E1 to E6) and the porous sintered body (sample C1) according to the second exemplary embodiment of the present invention.

In FIG. 10, the horizontal axis indicates Arrhenius plot 1000 T⁻¹ (K⁻¹) of a detection temperature, and the vertical axis indicates logarithm (5 cm⁻¹) of electric conductivity.

As shown in FIG. 10, the electric conductivity of the proton conductor (each of the samples E1 to E6) has a high value rather than the electric conductivity of the porous sintered body (sample C1). The sample E1 heated at a temperature of 600° C. has the most excellent electric conductivity.

As can be understood from the detection results shown in FIG. 10, the more the heating temperature is increased, the more the electric conductivity of the sample is increased. However, the electric conductivity of the sample is decreased at a temperature of 700° C. Therefore it is preferable to have the heating temperature within a range of not less than 300° C. to not more than 650° C. It is most preferable to have a heating temperature of not less than 400° C. to not more than 650° C.

The second exemplary embodiment indicates that a superior proton conductor can be obtained when a porous sintered body made of tetravalent metallic oxide is immersed into (or is in contact with) liquid solvent containing phosphate and heated in order to produce the proton conductor (such as each of the samples E1 to E6).

### Third Exemplary Embodiment

A description will be given of the third exemplary embodiment which detects a relationship between a porosity of a porous sintered body and a proton conductivity of a proton conductor (will also be called to as the “proton conductivity” for short). The third exemplary embodiment detects an electric conductivity of each of proton conductors (as samples E1, E7 and E8) having a different porosity.

Specifically, three porous sintered bodies (as samples C1, C2 and C3) are produced by changing a quantity of pore forming agent which is removed when porous are formed in the porous sintered body.

The sample C1, as previously shown in the first exemplary embodiment, the sample C1 is the porous sintered body made by adding 8.7 mass. % of carbon as a pore forming agent into 100 mass. % of tin (IV) oxide (SnO₂). The sample C1 has a porosity of 39.7%.

On the other hand, the sample C2 is the porous sintered body made by adding 4.2 mass. % of carbon as a pore forming agent into 100 mass. % of tin (IV) oxide (SnO₂). The sample C2 has a porosity of 31.8%.

The sample C3 is the porous sintered body made by adding 2.0 mass. % of carbon as a pore forming agent into 100 mass. % of tin (IV) oxide (SnO₂). The sample C3 has a porosity of 22.8%.

The samples C2 and C3 are produced by the same method of the sample C1 of the first exemplary embodiment other than the quantity of such a pore forming agent.

Next, the proton conductor (each of the samples E1, E7 and E8) is produced by using each of the porous sintered bodies (the samples C1, C2 and C3).

The sample E1 is a proton conductor, which is the same of the first exemplary embodiment, made of the porous sintered body (the sample C1).

The sample E7 is a proton conductor made of the porous sintered body (the sample C2). The sample E8 is a proton conductor made of the porous sintered body (the sample C3).

The samples E7 and E8 are produced by the same method of the sample E1 of the first exemplary embodiment other than the use of the samples C2 and C3.

An electric conductivity of each of the samples E1, E7 and E8 and the samples C1, C2 and C3 is detected by AC four electrode method like the second exemplary embodiment previously described.

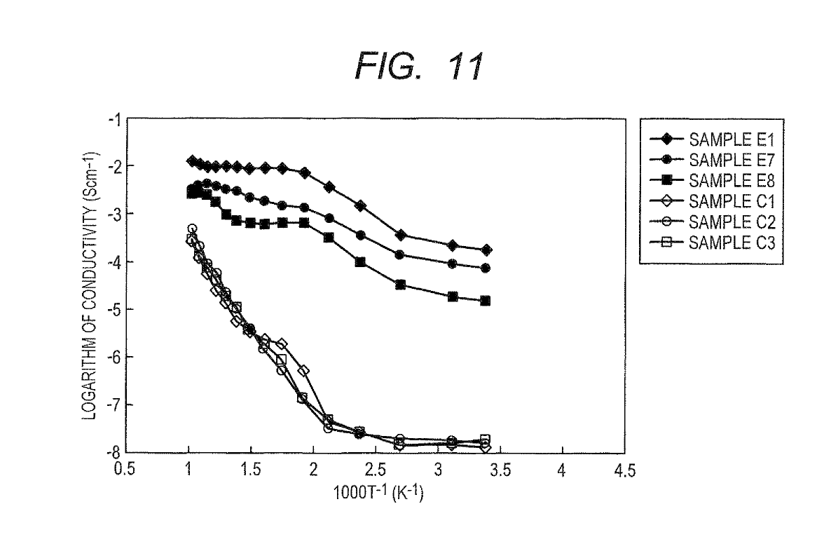

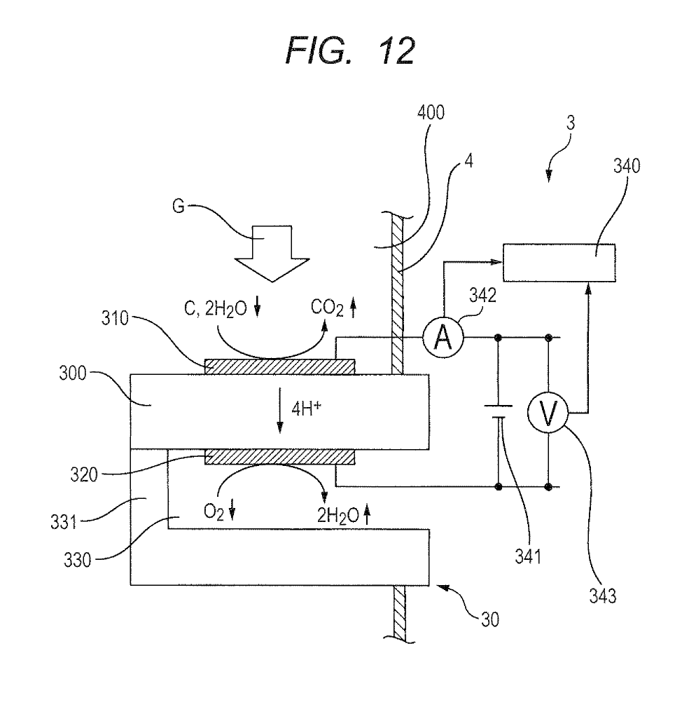

FIG. 11 is a view showing the relationship between the temperature and electric conductivity in the proton conductors (the samples E1, E7 and E8) and the porous sintered bodies (the samples C1 to C3) according to the third exemplary embodiment of the present invention.

In FIG. 11, the horizontal axis indicates Arrhenius plot 1000 T⁻¹ (K⁻¹) of a detection temperature, and the vertical axis indicates a logarithm (S cm⁻¹) of electric conductivity.

As shown in FIG. 11, each of the porous sintered bodies (as samples C1, C2 and C3) having a different porosity has not an adequate electric conductivity

On the other hand, each of the proton conductors (as samples E1, E7 and E8) has a superior electric conductivity, where the inside of porous formed in the porous sintered body in each of the proton conductors (as sample E1, E7 and E8) contains tin pyrophosphate (SnP₂O₇).

It can be understood from the detection results shown in FIG. 11, the more the porosity is increased, the more the electric conductivity is increased.

### Fourth Exemplary Embodiment

A description will be given of a carbon quantity detecting sensor composed of the proton conductor according to the fourth exemplary embodiment of the present invention.

FIG. 12 is a view showing a schematic configuration of a carbon quantity detecting sensor 3 according to the fourth embodiment of the present invention.

As shown in FIG. 12, the carbon quantity detecting sensor 3 is comprised of a proton conductor 300, a pair of electrodes composed of a measuring electrode 310 and a reference electrode 320, a power source (direct current power source) 341. The power source 341 supplies a predetermined current or voltage to the paired electrodes.

In the structure of the carbon quantity detecting sensor 3, the measuring electrode 310 faces a measuring gas G to be detected, and the reference electrode 320 is placed apart from the measuring gas G.

A description will now be given of the carbon quantity detecting sensor 3 in detail.

The carbon quantity detecting sensor 3 according to the fourth exemplary embodiment detects a quantity of carbon in particulate matter contained in an exhaust gas emitted from an internal combustion engine. On the basis of the detection result transferred from the carbon quantity detecting sensor 3, an arithmetic unit 340 (a) determines a timing to regenerate a diesel particulate filter (DPF), (b) executes an on-board diagnosis for detecting deterioration of performance of the DPF, and for detecting whether or not the DPF is damaged or broken, and (c) executes a rich spike control in order to decrease the quantity of PM and nitrogen oxide (NOx) contained in the exhaust gas.

As shown in FIG. 12, the carbon quantity detecting sensor 3 is fixed to the exhaust gas wall 4 through which exhaust gas flows so that a detection part of the carbon quantity detecting sensor 3 is placed in a measuring gas flow pipe 400. The detection part is composed of a carbon quantity detecting element 30 in the carbon quantity detecting sensor 3.

The carbon quantity detecting element 30 is comprised of the proton conductor 300, the measuring electrode 310 formed on one surface of the proton conductor 300 and the reference electrode 320 formed on the other surface of the proton conductor 300. The proton conductor 300 is produced by the same method to produce the sample E1 according to the first exemplary embodiment previously described.

The measuring electrode 310 is placed in and exposed to the measuring gas G. On the other hand, the reference electrode 320 is covered with a proton emission formation layer 331, and thereby separated apart from the measuring gas G.

The DC power source 34 is connected to the measuring electrode 310 and the reference electrode 320 so that the measuring electrode 310 is a positive electrode. As shown in FIG. 12, a current detection means 342 and/or a voltage detection means 343 is connected between the measuring electrode 310 and the reference electrode 320. The current detection means 342 detects a current generated between the measuring electrode 310 and the reference electrode 320 when a predetermined DC voltage is supplied to the electrode pair composed of the measuring electrode 310 and the reference electrode 320. The voltage detection means 343 detects a voltage generated between the measuring electrode 310 and the reference electrode 320.

The arithmetic unit 340 is connected to the current detection means 342 and the voltage detection means 343. The arithmetic unit 340 calculates a quantity of carbon contained in the measuring gas on the basis of the detection result of the current detection means 342 or the voltage detection means 343.

The exhaust gas as the measuring gas G generally contains soot, un-burned hydro carbon (HG), soluble organic fraction (SOF), particulate matter containing sulfur oxide, etc., and water vapor (H₂O) generated by fuel combustion in an internal combustion engine.

When a DC voltage is supplied to the electrode pair composed of the measuring electrode 310 and the reference electrode 320, a chemical reaction shown in the following equation (1) is generated. That is, reactive oxygen species are generated on the measuring electrode 310 by electro chemical reaction of water vapor. The reactive oxygen species burn carbon contained in PM of the measuring gas G and generate carbon dioxide.

C+2H₂O→CO₂+4H⁺+4e- (1).

Accompanied with proton moving in the proton conductor 300, the quantity of carbon and a current I or a voltage V have a correlation, where the carbon is decomposed on the surface of the measuring electrode 310, the current I flows between the measuring electrode 310 and the reference electrode 320, and the voltage V is generated between the measuring electrode 310 and the reference electrode 320.

Accordingly, it is possible to detect the quantity of carbon decomposed on the surface of the measuring electrode 310, namely, to detect a concentration of PM contained in the measuring gas G on the basis of the current I, which flows between the measuring electrode 310 and the reference electrode 320, detected by the current detection means 342, or on the basis of the voltage V, which is generated between the measuring electrode 310 and the reference electrode 320, detected by the voltage detection means 342.

Proton generated by electro chemical reaction with water vapor move to the reference electrode 320 through the inside of the proton conductor 300, are reacted with oxygen contained in atmosphere. Water (H₂O) is generated by electro chemical reaction, and exhausted to the outside of the proton conductor 300, as shown in FIG. 12.

In the carbon quantity detecting sensor 3 according to the fourth exemplary embodiment, because carbon contained in particulate matter PM in contact with the surface of the measuring electrode 310 is oxidized by reactive oxygen species such as oxygen ions having strong oxidizing capability generated by electro chemical reaction, there is no possibility of decreasing the sensor capability even if particulate matter PM is accumulated on the surface of the measuring electrode 310 in the carbon quantity detecting sensor 3.

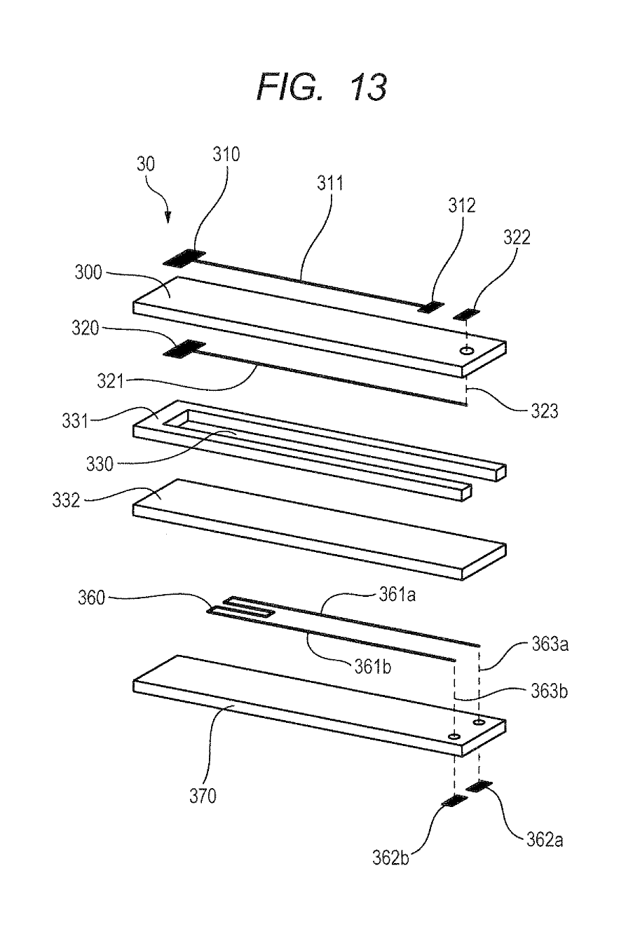

FIG. 13 is a view showing a development schematic configuration of a carbon quantity detecting element 30 in the carbon quantity detecting sensor 3 according to the fourth exemplary embodiment of the present invention.

In the fourth exemplary embodiment, the proton conductor 300 is produced by the same method of producing the sample E1 according to the first exemplary embodiment, as previously described.

The fourth exemplary embodiment uses the proton conductor 300 having a plate shape.

In the carbon quantity detecting element 30, shown in FIG. 13, the measuring electrode 310, a measuring electrode lead part 311, a measuring electrode terminal part 312, and a reference electrode terminal part 322 are formed on one surface of the proton conductor 300. The reference electrode 320 and a reference electrode lead part 321 are formed on the other surface of the proton conductor 300. The reference electrode lead part 321 is electrically connected to the reference electrode terminal part 322 through a through hole electrode 323 which is penetrated through the proton conductor 300. Each of the measuring electrode 310 and the reference electrode 320 is made of porous metal electrode or a cermet electrode by using a known method of forming an electrode such as thick film printing method, evaporation, plating, etc. The porous metal electrode contains at least one of gold (Au), platinum (Pt), palladium (Pd) and silicon carbide (SiC).

It is possible to form the measuring electrode lead part 311, the measuring electrode terminal part 312, the reference electrode lead part 321, the reference electrode terminal part 322 and the through hole electrode 323 which contain conductive metal by a known method of forming a conductive film such as a thick film printing, evaporation, plating, etc.

In the carbon quantity detecting element 30 in the proton conductor 300 shown in FIG. 13, a proton exhaust path forming layer 331 and a bottom layer 332 are formed in a stacked structure on the surface of the reference electrode 320.

Each of the proton exhaust path forming layer 331 and the bottom layer 332 is made of insulation ceramics such as alumina Al₂O₃ and formed in a plate shape by doctor blade method or press-formed molding method.

As shown in FIG. 13, the proton exhaust path forming layer 331 approximately has a longitudinal plate shape in which a part is cut such as a character “C” shape. The proton exhaust path forming layer 331 has a proton exhaust path 330.

It is possible to produce the carbon quantity detecting element 30 by stacking and firing the proton conductor 300 with the measuring electrode 310 and the reference electrode 320, the proton exhaust path forming layer 331 and the bottom layer 332.

In addition, as shown in FIG. 13, a heater part is formed in the carbon quantity detecting element 30 in order to heat the proton conductor 300.

Specifically, the heater part is comprised of a heating base body 370, a heating body 360, heating body lead parts 361a and 361b, heating body terminal parts 362a and 362b, and heating body through holes 363a and 363b. The heating body 360 is formed on a surface of the heating base body 370 at the proton conductor 300 side.

The heating body terminal parts 362a and 362b are formed on the other surface of the heating base body 370 which is opposite to the surface on which the heating body 360 is formed. Through the heating body through holes 363a and 363b, the heating body lead parts 361a and 361b are connected to the heating body terminal parts 362a and 362b, respectively.

The heater part is formed on the bottom surface of the bottom layer 332 of the carbon quantity detecting element 30 by stacking and firing it.

When a predetermined electric power is supplied to the heater part, a temperature of the heating body 360 becomes at a high temperature, and generates heat energy. This makes it possible to activate the proton conductor 300. The proton conductor 300 can stably detect a quantity of carbon contained in the measuring gas G.

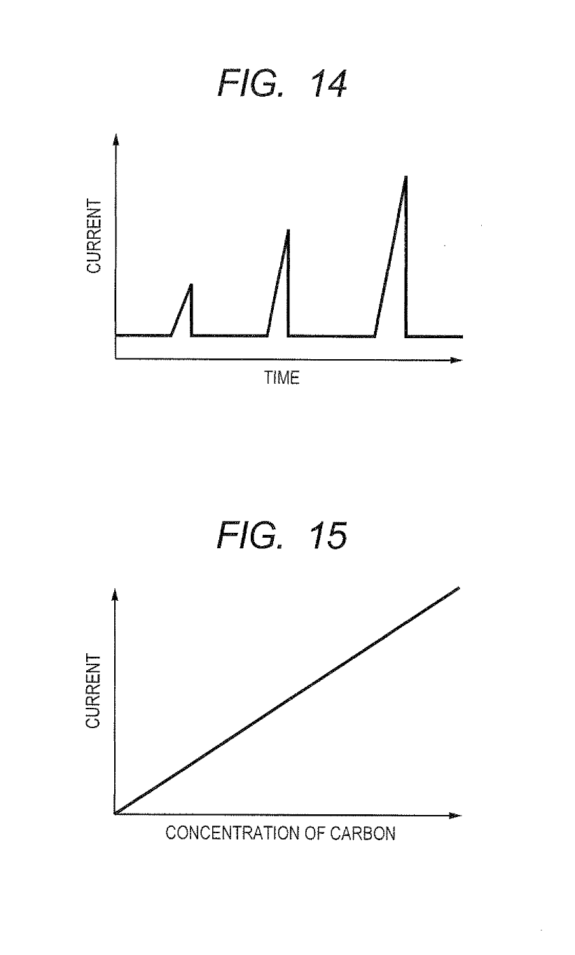

A description will now be given of the output change of the carbon quantity detecting sensor according to the fourth embodiment of the present invention with reference top FIG. 14 and FIG. 15.

FIG. 14 is a view showing a relationship between a detection time and a detection current by the carbon quantity detecting sensor according to the fourth embodiment of the present invention. FIG. 15 is a view showing a relationship between a carbon concentration and a detection current of the carbon quantity detecting sensor according to the fourth embodiment of the present invention.

Specifically, the fourth exemplary embodiment uses a measuring gas which contains a predetermined concentration of carbon and wet air containing 3 volume % of water vapor. The measuring gas G is heated at a predetermined temperature (for example, 20° C.) and supplied to the carbon quantity detecting sensor 3 (see FIG. 12).

A predetermined voltage (for example, 0.4 V) is supplied from an outside electric power source to the electrode pair composed of the reference electrode 320 and the measuring electrode 310. The arithmetic unit 340 detects a current which flows through the measuring electrode 310 when carbon contained in the measuring gas G is in contact with the surface of the measuring electrode 310 and electro chemical reaction occurs between the carbon and the surface of the measuring electrode 310. FIG. 14 shows such detection results.

The current detection means 342 detects a current generated by the electro chemical reaction (see FIG. 12) when carbon reaches the measuring electrode 310, the electro chemical reaction previously described occurs. However, as shown in FIG. 14, the carbon quantity detecting sensor 3 according to the fourth exemplary embodiment has the feature in which the more the concentration of carbon contained in the measuring gas G is increased, the more the detection current is increased. This makes it possible to predict or calculate a concentration of carbon (PM concentration) contained in a measuring gas on the basis of the relationship between detection current and a concentration of carbon.

As described above in detail, the fourth exemplary embodiment provides the carbon quantity detecting sensor 3 equipped with the proton conductor (sample E1) which is produced by immersing a porous sintered body made of tetravalent metallic oxide into liquid solvent containing phosphate (or by being a porous sintered body made of tetravalent metallic oxide in contact with liquid solvent containing phosphate), and then heating the porous sintered body. The obtained carbon quantity detecting sensor 3 can detect the quantity of carbon contained in a measuring gas with high accuracy.

### (Other Features of the Present Invention)

The present exemplary embodiment provides the proton conductor having the porous sintered body made of tetravalent metallic oxide. Pyrophosphate is a tetravalent metallic compound and formed on surfaces and porous walls of the porous sintered body, and in the inside of each pores of the porous sintered body. The present exemplary embodiment provides the method of producing the proton conductor. The method has a step of contacting the porous sintered body made of tetravalent metallic oxide with liquid solvent containing phosphate (or of immersing the porous sintered body into the liquid solvent containing phosphate), and a step of heating the porous sintered body so that the pyrophosphate which is a tetravalent metallic compound is formed on a surface and porous wall and in an inside of the pores of the porous sintered body.

It is preferred that the tetravalent metallic oxide contains a metallic element selected from Tin (Sn), titanium (Ti), silicon (Si), germanium (Ge), zirconium (Zr) and cerium (Ce)

For example, when a porous sintered body made of tin (IV) oxide (SnO₂) is used, it is possible to produce a proton conductor in which the surfaces and porous walls of the porous sintered body are covered with tin pyrophosphate (SnP₂O₇) and the inside of each pore of the porous sintered body contains tin pyrophosphate (SnP₂O₇).

Further, when a porous sintered body made of titanium (IV) oxide (TiO₂) or silicon (IV) oxide (SiO₂) is used, it is possible to produce a proton conductor in which the surfaces and porous walls of the porous sintered body are covered with titanium (IV) pyrophosphate or silicon (IV) pyrophosphate and the inside of each pore of the porous sintered body contains titanium (IV) pyrophosphate or silicon (IV) pyrophosphate.

Still further, when a porous sintered body made of germanium (IV) oxide, zirconium (IV) oxide or cerium (IV) oxide is used, it is possible to produce a proton conductor in which the surfaces and porous walls of the porous sintered body are covered with germanium pyrophosphate, zirconium pyrophosphate or cerium pyrophosphate, and the inside of each pore of the porous sintered body contains germanium (IV) pyrophosphate, zirconium (IV) pyrophosphate or cerium (IV) pyrophosphate.

It is preferable to select, as the tetravalent metallic element forming the tetravalent metallic oxide, one of tin (Sn), titanium (Ti), cerium (Ce) and zirconium (Zr). This makes it possible to more increase the proton conductivity of the proton conductor. It is more preferable to use tin (Sn) as the tetravalent metallic compound.

In the method according to the present exemplary embodiment, it is preferred to use the porous sintered body having a porosity within a range of 10 to 50% before the step of immersing or being in contact with the liquid solvent containing phosphate and before the step of firing the porous sintered body.

When the porosity of the porous sintered body is less than 10%, there is a possibility of it being difficult for the proton conductor to form pyrophosphate having an adequate quantity on the pores walls and in the inside of the pores.

On the other hand, when the porosity of the porous sintered boys is more than 50%, there is a possibility of it being difficult for the proton conductor to obtain an adequate air-tightness capability.

Therefore it is preferable for the porous conductor to have the porosity within a range of not less than 20% to not more than 45%.

It is more preferable for the porous conductor to have the porosity within a range of not less than 30% to not more than 40%.

It is possible to detect the porosity of the porous sintered body by the following method.

A bulk density of the porous sintered body is detected on the basis of a mass and a volume of the porous sintered body. (Bulk density=mass/volume)

A relative density of the porous sintered body is calculated on the basis of the calculated bulk density and a true density (theoretical value) (Relative Density=Bulk Density/True Density)

Next, a porosity of the porous sintered body is calculated on the basis of the calculated relative density. (Porosity=(1−relative density)×100))

In the above method of producing the proton conductor, it is possible to use liquid solvent containing phosphate. For example, it is possible to immerse the porous sintered body into the liquid solvent containing phosphate and then to fire the porous sintered body.

It is also possible to use heat the porous sintered body while at least a part of the porous sintered body is immersed into the liquid solvent containing phosphate in an air-tight container.

It is preferable that the porous sintered body is heated at a temperature within a range of 200 to 700° C.

This makes it possible to form pyrophosphate adequately on the surfaces and porous walls of the porous sintered body and in the inside of each pore formed in the porous sintered body. This makes it possible to increase the proton conductivity, the mechanical strength and the air-tightness capability of the proton conductor.

When the heating temperature is less than 200° C., it is impossible to adequately generate pyrophosphate. This has a possibility of it being impossible for the proton conductor to provide a necessary proton conductivity, etc.

On the other hand, when the heating temperature is more than 700° C., cracks are generated in the porous sintered body. This decreases the air-tightness capability and the proton conductivity. It is more preferable to have the heating temperature within a range of not less than 300° C. and not more than 650° C. It is most preferable to have the heating temperature of not less than 400° C. and not more than 650° C.

Pyrophosphate as a tetravalent cation is generated, as previously described. At the same time, there is a possibility of occurring extraction or combination of phosphoric acid and water (hydrate) in addition to pyrophosphate. These materials can increase the electric conductivity of the produced proton conductor.

It is preferable for the method to mix a pore forming agent and a metallic oxide element such as the tetravalent metallic oxide (as previously described) together in order to make a mixture, and to mold and fire the mixture in order to produce the porous sintered body.

This method makes it possible to easily produce the porous sintered body made of the above metallic element oxide.

The pore forming agent is carbon, etc. It is possible to add the pore forming agent within a range of 1 to 20 mass. % into the metallic oxide element of 100 mass. %. It is preferable to add the pore forming agent within a range of 2.0 to 10 mass. % into the metallic oxide element of 100 mass. %. Further, it is more preferable to add the pore forming agent within a range of 2.0 to 8.7 mass. % into the metallic oxide element of 100 mass. %.

Next, the carbon quantity detecting sensor according to the present exemplary embodiment has the proton conductor, the measuring electrode, the reference electrode, and the power source. The measuring electrode and the reference electrode make the paired electrodes. The measuring electrode is formed on one surface of the proton conductor, and the reference electrode is formed on the other surface of the proton electrode. The power source supplies a predetermined current or voltage to the electrode pair composed of the measuring electrode and the reference electrode.

Specifically, the above carbon quantity detecting sensor is comprised of the proton conductor of a plate shape, and the pair of the electrodes formed on both the surfaces of the proton conductor, respectively. One electrode forms the measuring electrode, and the other electrode forms the reference electrode. The power source is electrically connected to the paired electrodes.

It is preferable for the electric power source to supply a predetermined current or voltage to the electrode pair composed of the measuring electrode and the reference electrode in order to generate electro chemical reaction on the measuring electrode on which carbon component contained in a measuring gas and water vapor are reacted together.

This makes it possible to generate reactive oxygen species on the measuring electrode by electrolysis of water vapor contained in the measuring gas, and for the generated reactive oxygen species to oxidize carbon component contained in the measuring gas. Accordingly, the reactive oxygen species burn carbon contained in PM of the measuring gas G and generate carbon dioxide. This makes it possible to prevent carbon component contained in the measuring gas from being accumulated on the measuring electrode. Therefore it is possible for the present invention to provide the carbon quantity detecting sensor with high reliably for a long period of time.

Specifically, it is preferable to have a voltage potential detection means capable of detecting a voltage potential generated between the measuring electrode and the reference electrode when a predetermined current is supplied to the above electrode pair.

This makes it possible to calculate the quantity of carbon contained in the measuring gas on the basis of the change of the voltage potential corresponding to the supplied current value while the voltage potential is continuously monitored. Accordingly, it is possible to provide the carbon quantity detecting sensor with high reliably for a long period of time without accumulating carbon component contained in the measuring gas on the measuring electrode.

Still further, it is possible to supply a predetermined voltage to the electrode pair and a current detection means detects a current flowing between the paired electrodes.

This makes it possible to calculate the quantity of carbon component contained in the measuring gas on the basis of a detected current value while carbon component contained in the measuring gas is oxidized. Accordingly, it is possible to provide the carbon quantity detecting sensor with high reliably for a long period of time without accumulating carbon component contained in the measuring gas on the measuring electrode.

In the carbon quantity detecting sensor according to the present exemplary embodiment, it is possible to form each of the measuring electrode and the reference electrode by using one of a porous metal electrode and a cermet electrode. In particular, such a porous metal electrode contains one of gold (Au), platinum (Pt), palladium (Pd) and silicon carbide (SiC).

Further, it is preferable for the carbon quantity detecting sensor to have a heater part. The heater part heats the proton conductor to a predetermined temperature when receiving electric power.

Because this structure of the carbon quantity detecting sensor provides a stable temperature of the proton conductor, it is possible for the carbon quantity detecting sensor to detect the quantity of carbon component contained in the measuring gas with high accuracy for a long period of time.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A proton conductor comprising a porous sintered body made of tetravalent metallic oxide, wherein pyrophosphate as a tetravalent metallic compound is further formed on surfaces of the porous sintered body, porous walls of the porous sintered body, and in the inside of each pore of the porous sintered body.

2. The proton conductor according to claim 1, wherein the tetravalent metallic oxide contains a metallic element selected from Tin (Sn), titanium (Ti), silicon (Si), germanium (Ge), zirconium (Zr) and cerium (Ce).

3. A method of producing a proton conductor comprising steps of:
contacting a porous sintered body made of tetravalent metallic oxide with liquid solvent containing phosphate; and
heating the porous sintered body so that the pyrophosphate as a tetravalent metallic compound is formed on a surface and porous wall and in an inside of the pores of the porous sintered body.

4. The method of producing a proton conductor according to claim 3, wherein the tetravalent metallic oxide contains a metallic element selected from Tin (Sn), titanium (Ti), silicon (Si), germanium (Ge), zirconium (Zr) and cerium (Ce).

5. The method of producing a proton conductor according to claim 3, wherein the porous sintered body is heated at a temperature within a range of 200 to 700° C.

6. The method of producing a proton conductor according to claim 3, wherein the porous sintered body is produced by mixing pore forming agent and the tetravalent metallic oxide together in order to make a mixture, and molding and firing the mixture.

7. A carbon quantity detecting sensor placed in a gas flow passage through which a measuring gas containing carbon component flows, and detecting a quantity of carbon contained in the measuring gas, the carbon quantity detecting sensor comprising:
the proton conductor according to claim 1;
a pair of a measuring electrode and a reference electrode formed on both surfaces of the proton conductor so that the measuring electrode faces the measuring gas and the reference electrode is apart from the measuring gas; and
an electric power source configured to supply a predetermined current or a predetermined voltage to the electrode pair composed of the measuring electrode and the reference electrode.

8. The carbon quantity detecting sensor according to claim 7, wherein each of the measuring electrode and the reference electrode is comprised of one of a porous metallic electrode and a cermet electrode, the porous metallic electrode containing one of gold (Au), platinum (Pt), palladium (Pd) and silicon carbide (SiC).

9. The carbon quantity detecting sensor according to claim 7, further comprising a heater part capable of heating the proton conductor to a predetermined temperature when receiving electric power.
